(19) United States
(12) Patent Application Publication
(10) Pub. No.: US 2011/0255288 A1
(43) Pub. Date: Oct. 20, 2011

(54) LIGHT ILLUMINATION SYSTEMS AND METHODS THEREOF

(75) Inventors: Lesley Wexler, Libertyville, IL (US); Stephen Cheung, Shatin (HK)

(73) Assignee: JETMAX LTD., Shatin (HK)

(21) Appl. No.: 12/763,617

(22) Filed: Apr. 20, 2010

(51) Int. Cl. F21S 4/00; F21V 21/00

(52) U.S. Cl. 362/249.06; 362/382; 362/249.01

(57) ABSTRACT

A light illuminating system and method including a transparent shaft that extends vertically from a base and/or a positioner. A channel extends through the body of the transparent shaft. The channel being capable of receiving a string of lights which illuminate the transparent shaft. An object having a shape can be placed over the illuminated vertically extending transparent shaft such that the object becomes illuminated.

### FIELD OF THE INVENTION

The present invention relates to light illumination systems and methods capable of illuminating a shaped transparent object.

### BACKGROUND

During various times of the year houses and business can be decorated celebrating festivities. For example, for Halloween many houses are decorated with ghost-like figures. Many find these decorations enhance the holidays. However, if these decorations are placed in a dark location they can be substantially difficult, if not impossible, to see.

Some have used lighting fixtures to increase the visibility of decorations. For example, a house decorated during Halloween can include a spotlight shined on it such that the decorations can be seen at night. This spotlight can be focused on a decoration from one side causing light to reflected back illuminating that side of the decoration. That is, not every side of the decoration is illuminated. Further, spotlights can be substantially inefficient as they can require a substantially large amount of energy to illuminate a decoration and more than one spotlight may be needed to illuminate more than one side of a decoration.

Further, lighting fixtures can be used to better identify an object. For example, driveways can include periphery lights that indicate the edge of the driveway. These periphery lights can assist a driver in parking their car and can increase driver safety. However, these periphery lights (and many other lights sources) are typically bland and can add very little to the esthetics of a property (e.g., they typically do not enhance the holidays).

Although the above methods (and others) can increase the visibility of a decoration (e.g., enhancing the holidays) and/or can be used to identify an object (e.g., periphery lights identifying a driveway), further advancements can still be made.

### SUMMARY OF THE INVENTION

In some embodiments, a light illuminating system can include a positioner and/or a base and a first transparent shaft being coupled to the positioner and/or the base such that the transparent shaft extends vertically, and the first transparent shaft can include a hollow channel extending vertically through the first transparent shaft, the hollow channel being capable of receiving a string of lights for illuminating the first transparent shaft.

In some embodiments, the light illuminating system can include at least one transparent or translucent object being located on the transparent shaft such that when the first transparent shaft is illuminated the at least one transparent object can be illuminated.

In some embodiments, the transparent object can substantially encapsulate the length of the first transparent shaft and/or a portion of the length of the first transparent shaft.

In some embodiments, the transparent object can be a three-dimensional shape.

In some embodiments, the light illuminating system can include a second transparent shaft coupled to a first connector, the first connector being coupled to the first transparent shaft, the second transparent shaft and the first connector each can include a hollow channel that can be capable of receiving a string of lights.

In some embodiments, the positioner and the base can be substantially one unit.

In some embodiments, the transparent shaft, the positioner, and the base can be substantially one unit.

In some embodiments, the transparent shaft can be constructed of Polyvinyl Chloride.

In some embodiments, the transparent object can be constructed of at least one of a polymer and a fabric.

In some embodiments, at least two of the transparent shaft, base, and positioner can be connect by being at least partially placed into one another.

In some embodiments, the light illuminating system can include a cap, the cap can be located on top of the vertical axis of the transparent shaft. In some embodiments, the cap can include a connector for coupling the cap to a string of lights such that the string of lights can remain vertically disposed within the channel of transparent shaft.

In some embodiments, the first transparent shaft can include at least one opening connected to the hollow channel such that a string of lights can be received in the channel. In some embodiments, the opening can be located on the bottom of the vertical axis of the transparent shaft and/or on the sidewall of the transparent shaft. In some embodiments, the opening can be located on the sidewall of the transparent shaft such that the hollow channel can include a first external opening on the sidewall of the transparent shaft.

In some embodiments, the positioner and/or the base can include a hollow channel having a first opening and second opening, each of the hollow channels of the first transparent shaft and the positioner and/or the base being connected forming a single hollow channel inside the light illuminating system, the single hollow channel can have a first external opening located on the external surface of the positioner and/or the base.

In some embodiments, the first transparent shaft can include a first opening located on the top of the vertical axis of the transparent shaft and a second opening located on the bottom of vertical axis of the transparent shaft and/or on the sidewall of the transparent shaft, the first and second opening can connect to the hollow channel of the first transparent shaft. In some embodiments, the second opening can be located on the sidewall of the transparent shaft such that the hollow channel can have a first external opening on the sidewall of the transparent shaft and a second external opening located on the top of the vertical axis of the transparent shaft. In some embodiments, the positioner and/or the base can include a hollow channel having a first opening and second opening, each of the hollow channels of the first transparent shaft and the positioner and/or the base can be connected forming a single hollow channel inside the light illuminating system, and the single hollow channel can have a first external opening located on the external surface of the positioner and/or the base and a second external opening can be located substantially near the top region of the first transparent shaft.

In some embodiments, the base can include a substantially columnar shape having a substantially flat bottom surface and/or conical shaped having a substantially pointed bottom surface.

In some embodiments, the at least one transparent object can include a first opening and/or a second opening, such that the transparent object can be located on the transparent shaft by passing the transparent shaft through the first opening and/or second opening of the transparent object.

In some embodiments, the light illuminating system can include a second transparent object having a first opening and a second opening and the second transparent object can be located on the transparent shaft below the first transparent, the second transparent object can be located on the transparent shaft by passing the transparent shaft through the first and second opening.

In some embodiments, the transparent shaft can include an internal surface and an external surface and the internal surface of the transparent shaft can be substantially rough for, for example, frictionally positioning the string of lights in the transparent shaft.

In some embodiments, the transparent shaft can include an external surface and the transparent object can include an internal surface and the external surface of the transparent shaft and/or the internal surface of the transparent object can be substantially rough for, for example, frictionally positioning the transparent object on the transparent shaft.

In some embodiments, the transparent shaft can further comprise a plurality of transparent shaft elements capable of telescoping out.

In some embodiments, a method of illuminating an object can include placing a base and/or positioner on a surface and/or partially into a surface such that a transparent shaft extends vertically from the surface, the transparent shaft having a string of lights disposed within it, and illuminating the vertically extending transparent shaft.

In some embodiments, the method of illuminating an object can include placing an object over a vertically extending transparent shaft such that the transparent shaft can be at least partially encapsulated.

These and other features of this invention are described in, or are apparent from, the following detailed description of various exemplary embodiments of this invention.

### BRIEF DESCRIPTION OF THE DRAWINGS

The features and advantages of the present invention will be more fully understood with reference to the following, detailed description of an illustrative embodiment of the present invention when taken in conjunction with the accompanying figures, wherein:

FIGS. 1A-1B depict components of the system and method of the present invention;

FIG. 2A depicts a shaft component of the system and method of the present invention;

FIG. 2B depicts a telescoping shaft component of the system and method of the present invention;

FIGS. 3A-4 depict a base component of the system and method of the present invention;

FIGS. 5A-5B depict a positioner component of the system and method of the present invention;

FIGS. 6A-6B depict a positioner and base as a single component of the system and method of the present invention;

FIGS. 7A-7E depict a transparent component of the system and method of the present invention;

FIGS. 8A-8D depict a channel component of the system and method of the present invention;

FIG. 9 depicts a plurality of shafts and a connector component of the system and method of the present invention; and

FIG. 10 depicts a cap component of the system and method of the present invention.

### DETAILED DESCRIPTION OF THE EXEMPLARY EMBODIMENTS

In accordance with an exemplary embodiment of the invention, a light illuminating system and method can illuminate an ornamental object located on a portion of a vertically extending shaft. In accordance with an exemplary embodiment of the invention, the light illuminating system and method can include a base and/or positioner that can be located on a substantially flat surface and/or placed at least partially into a surface. For example, the light illuminating system and method can be used to light up a Halloween ornament located on an illuminated vertically extending shaft attached to a base and/or positioner located on a surface (e.g., the periphery of a driveway).

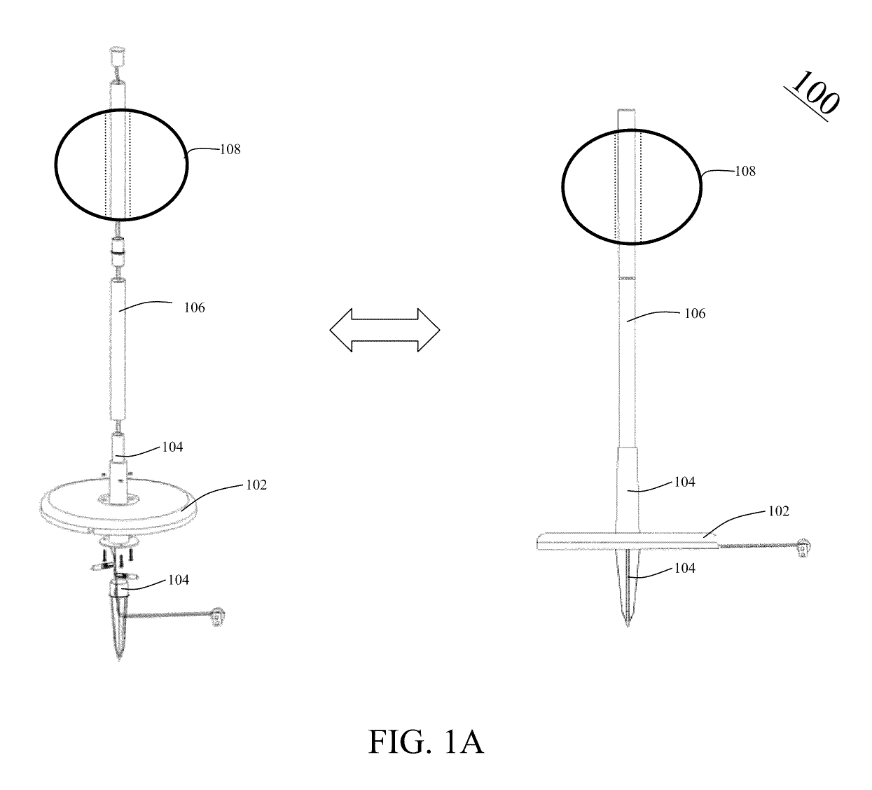

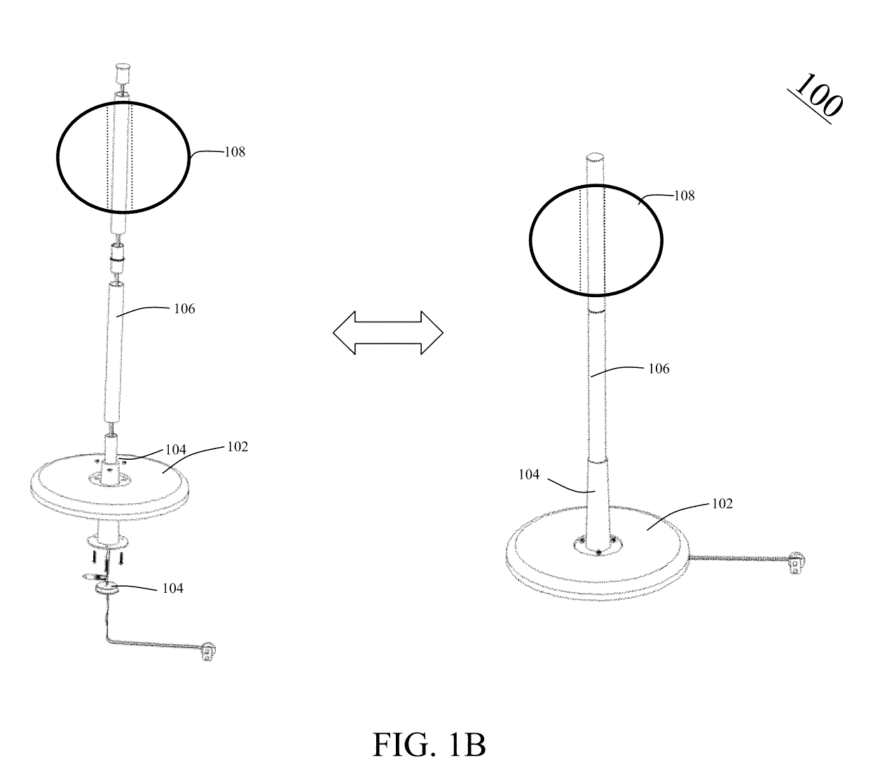

Referring to FIG. 1A-1B, in accordance with an exemplary embodiment of the invention, a light illuminating system 100 can include a positioner 102 that can be coupled to a base 104 that can be coupled to a shaft 106 that can extend vertically from base 104. It will be understood that positioner 102 and base 104 can be substantially one unit. For ease, positioner 102 and base 104 are illustrated as separate units, this is in no way meant to be a limitation.

In accordance with an exemplary embodiment of the invention, at least one object 108 can be located on shaft 106 (e.g., object 108 can substantially encapsulate at least some of shaft 106). In accordance with an exemplary embodiment of the invention, a string of lights can be located within light illuminating system 100 (e.g., illuminating through shaft 106 and/or object 108).

In accordance with an exemplary embodiment of the invention, a string of lights can include any reasonable light source such as, but is not limited to, light-emitting diodes (LEDs), incandescent lights, fiber optic lights, bubble lights, or any other reasonable light source capable of illuminating. In accordance with an exemplary embodiment of the invention, the string of lights can use line voltage (e.g., 120 volts), a power supply (e.g., batteries), and/or a power converter (e.g., capable of providing a desired voltage and/or amperage).

In accordance with an exemplary embodiment of the invention, shaft 106 and/or object 108 can allow at least some light to pass through them (e.g., transparent, translucent, etc.). For example, shaft 106, can be constructed of a substantially transparent material (e.g., allowing light to pass it) and object 108 can be constructed of a substantially translucent material (e.g., allowing only some light to pass through it). It will be understood that shaft 106 and object 108 can be constructed of any material capable of allowing shaft 106 and/or object 108 to become illuminated. For ease, shaft 106 and object 108 will be described as being transparent, this is in no way meant to be a limitation.

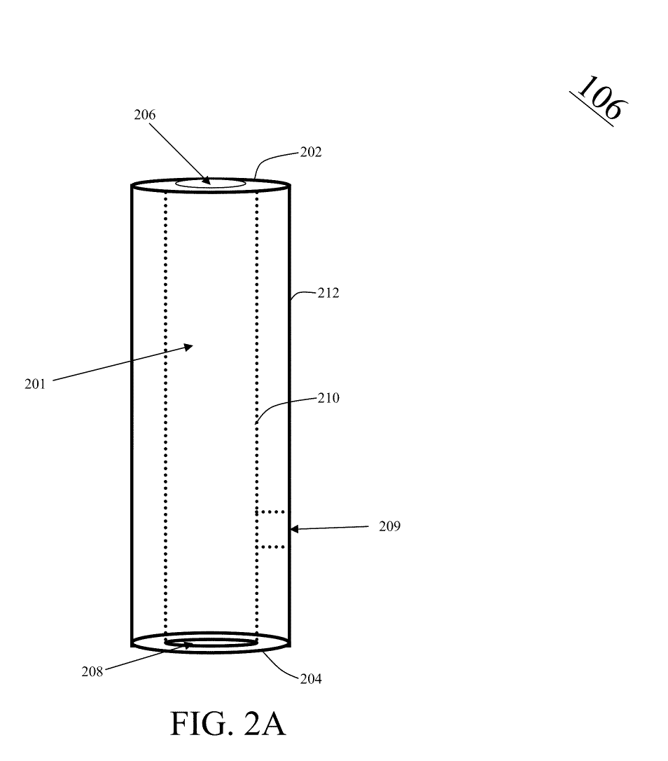

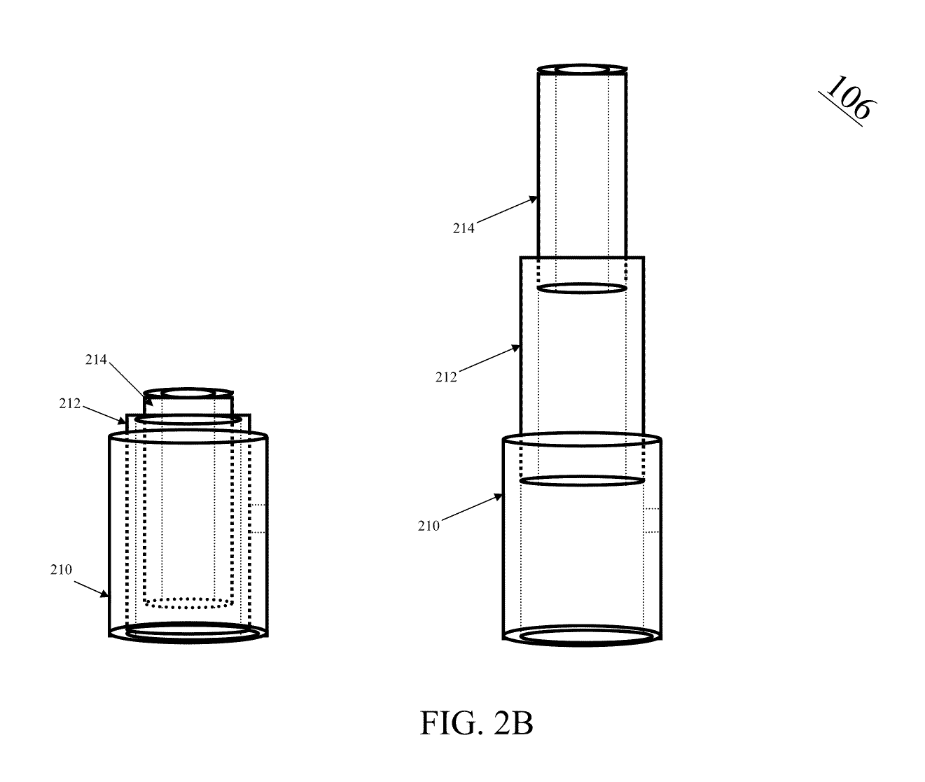

Referring to FIGS. 2A-2B, in accordance with an exemplary embodiment of the invention, transparent shaft 106 can be substantially columnar in shape and can have an opening passing from the top of the transparent shaft to the bottom of the transparent shaft. For example, referring to FIG. 2A, transparent shaft 106 can be a substantially rigid transparent tube. In accordance with an exemplary embodiment of the invention, transparent shaft 106 can be substantially columnar in shape and can have an opening located at its bottom and/or in its sidewall. For example, although not shown, shaft 106 can be a substantially rigid transparent tube with only one opening (e.g., shaft 106 can be closed at its top).

In accordance with an exemplary embodiment of the invention, transparent shaft 106 can be designed to receive a string of lights through the length of its transparent shaft. For example, transparent shaft 106 can include a channel 201 extending through the length of transparent shaft 106. In accordance with an exemplary embodiment of the invention, channel 201 can be concentrically located within the length of transparent shaft 106.

In accordance with an exemplary embodiment of the invention, transparent shaft 106 can include a top surface 202 (e.g., that may or may not include an opening 206) and a bottom surface 204 including an opening 208. In accordance with an exemplary embodiment of the invention, transparent shaft 106 can include a top surface 202 (e.g., that may or may not include an opening 206), a bottom surface 204 (e.g., that may or may not include an opening 206), and a sidewall 203 including an opening 209. In accordance with an exemplary embodiment of the invention, opening 209 can be located at any reasonable location on sidewall 203. For ease, opening 209 is illustrated as being located substantially near bottom surface 204, this is in no way meant to be a limitation.

In accordance with an exemplary embodiment of the invention, transparent shaft 106 can include channel 201 such that transparent shaft 106 can include an internal surface 210 and an external surface 212. In accordance with an exemplary embodiment of the invention, transparent shaft 106 can be constructed of a single material and/or can be constructed of a plurality of materials (e.g., a first material strengthened by a second material). For example, transparent shaft 106 can be constructed of a first material and a wire-like material can be imbedded in the first material.

In accordance with an exemplary embodiment of the invention, opening 206, opening 208, and/or opening 209 can be any reasonable shape, such as, but not limit to round, square, polygonal, triangular, star shaped, or any other reasonable shape for receiving a string of lights. For ease, opening 206, opening 208, and/or opening 209 are depicted as round, this is in no way meant to be a limitation. Further, channel 201 can follow any desired path. For example, channel 201 can change shape when connecting opening 206, opening 208, and/or opening 209. By way of example, opening 206, opening 208, and/or opening 209 may be square however the length of channel 201 connecting the square openings can be substantially round.

In accordance with an exemplary embodiment of the invention, transparent shaft 106 can have any reasonable columnar shape, such as, but not limited to, round columnar, square columnar, polygonal columnar, star columnar, triangular columnar, or any other reasonable columnar shape. For ease, each of the figures illustratively depicts transparent shaft 106 as having a round columnar shape, this is in no way meant to be a limitation.

In accordance with an exemplary embodiment of the invention, internal surface 210 and external surface 212 can be substantially smooth and/or can be substantially rough. Internal surface 210 can be substantially smooth, for example, to ease the passage of a string of lights through transparent shaft 106. Internal surface 210 can be substantially rough, for example, to allow frictional positioning of a string of lights placed in transparent shaft 106.

In accordance with an exemplary embodiment of the invention, transparent shaft 106 can be constructed of a substantially transparent material capable of having light pass through it. For example, transparent shaft 106 can be made of a transparent plastic material (e.g., transparent Polyvinyl Chloride-PVC, etc.) capable of allowing light to pass through it.

Referring to FIG. 2B, in accordance with an exemplary embodiment of the invention, transparent shaft 106 can be constructed such that the transparent shaft can telescope out. For example, transparent shaft 106 can be constructed of a plurality of transparent shaft elements 210, 212, and 214 capable of the moving such that transparent shaft element 212 can slide out of transparent shaft element 210 and transparent shaft element 214 can slide out of transparent shaft element 212.

Transparent shaft 106 can telescope out and remain vertically extended via frictional interactions between the walls of each of the transparent shaft elements combined together yielding transparent shaft 106. Further, transparent shaft 106 can include at least one locking element (not shown) capable of locking a telescoped out transparent shaft 106. The locking element can be, but is not limited to, a pin or other object pushed through an opening in one or more of the transparent shaft elements, a thread connection type interaction between transparent shaft elements, or any reasonable technique for maintaining a telescoped out transparent shaft 106 in a vertical direction.

It will be understood that any plurality of transparent shaft elements can be combined creating a transparent shaft 106 capable of telescoping out. Accordingly, any descriptions herein with regards to transparent shaft 106 can be applied to any of the transparent elements and/or to a transparent shaft capable of telescoping out. For ease, at times only a transparent shaft is described, this is in no way meant to be a limitation.

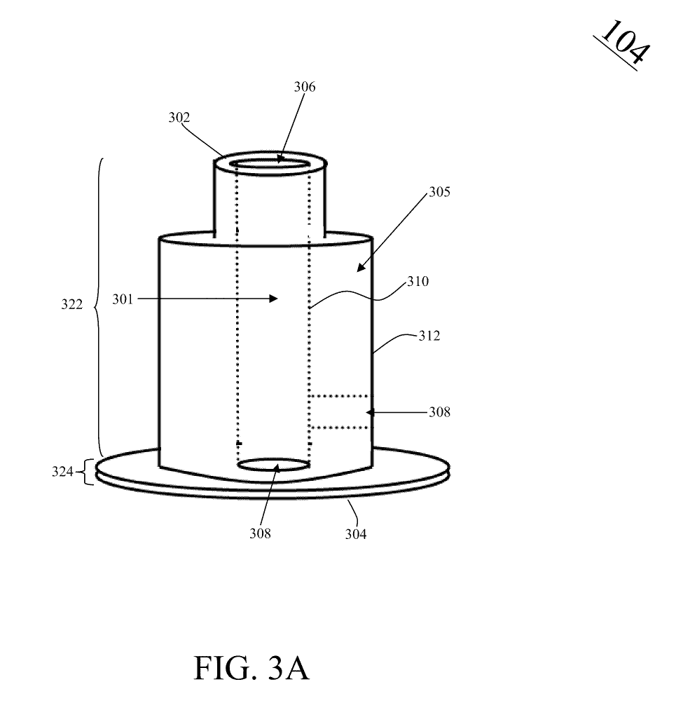

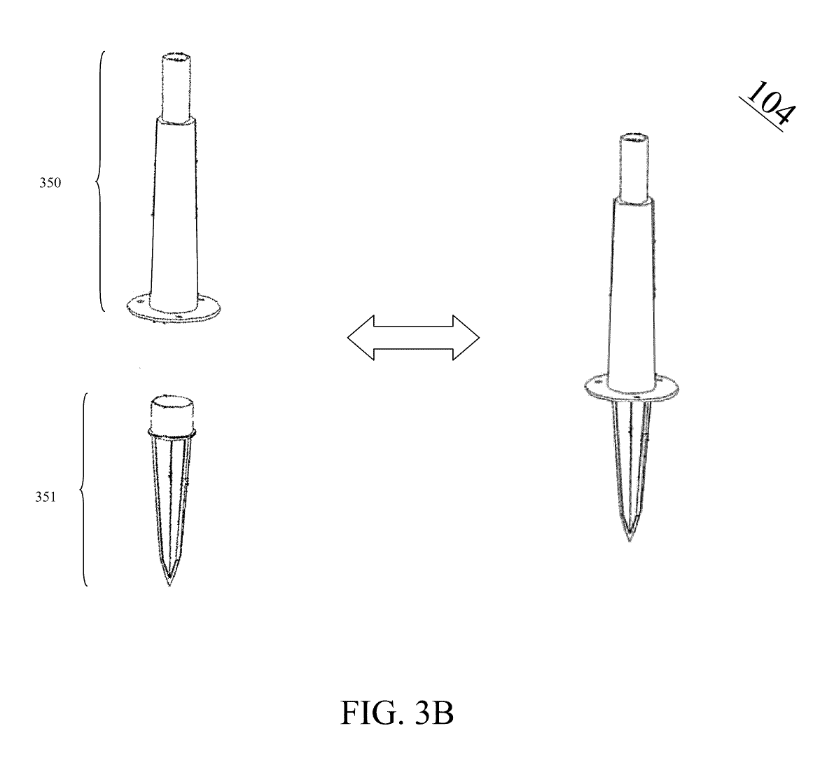

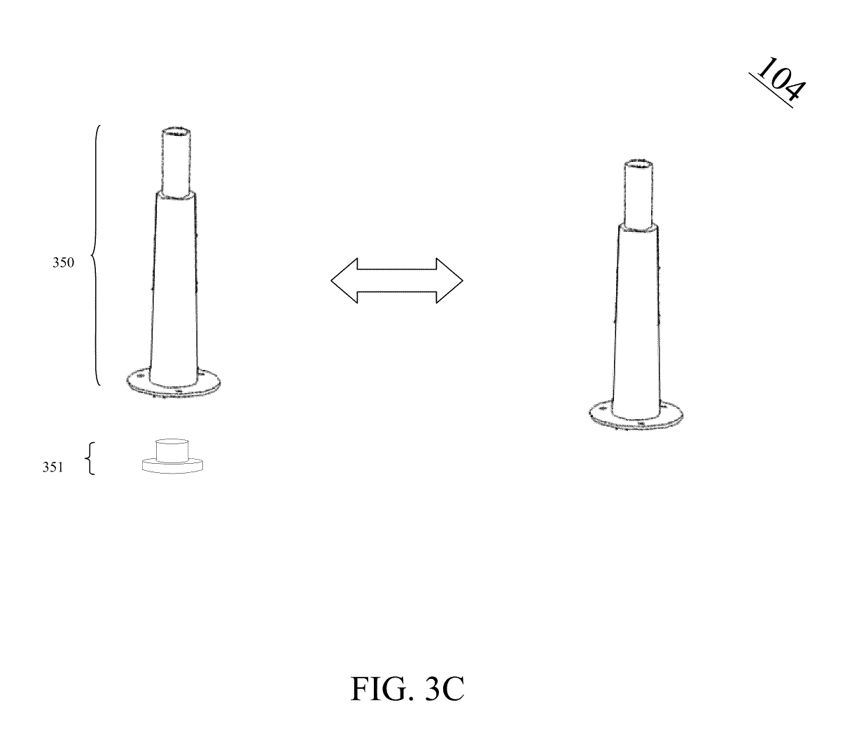

Referring to FIG. 3A, in accordance with an exemplary embodiment of the invention, base 104 can be at least one substantially rigid body and can include an opening passing from the top of the body to at least one of the bottom of the body and/or a side of the body.

In accordance with an exemplary embodiment of the invention, base 104 can be designed to receive a string of lights. For example, base 104 can include a channel 301 extending through the body of base 104. Base 104 can include a top surface 302 including an opening 306, a bottom surface 304, and a sidewall surface 305. Further, an opening 308 can be located in either bottom surface 304 and/or sidewall surface 305. A material can extend from top surface 302 to bottom surface 304. As the material extends from top surface 302 to bottom surface 304, channel 301 can be created connecting opening 308 and opening 306 such that base 104 can include an internal surface 310 and an external surface 312.

In accordance with an exemplary embodiment of the invention, opening 306 and opening 308 can be any reasonable shape, such as, but not limit to round, square, polygonal, triangular, star shaped, or any other reasonable shape for receiving a string of lights. For ease, openings 306 and 308 are depicted as round, this is in no way meant to be a limitation. Further, channel 301 connecting opening 306 and opening 308 can follow any desired path. For example, channel 301 can change shape when connecting opening 306 and opening 308. By way of example, opening 306 and 308 may be square however the length of channel 301 connecting the square openings can be substantially round.

Referring to FIG. 3B-3C, in accordance with an exemplary embodiment of the invention, base 104 can include a top component 350 and a bottom component 351 which can combine to form base 104. It will be understood that top component 350 and bottom component 351 can be combined by any reasonable technique. For ease, base 104 is illustrated such that a region of bottom component 351 is placed with in a region of top component 350.

Referring to FIG. 3B, in accordance with an exemplary embodiment, base 104 can include a conical shaped bottom which tapers to a substantial point. A conical shaped bottom can be used to place at least a portion of base 104 into another object such as the earth, dirt, and a planting fixture, to name a few. Referring to FIG. 3C, in accordance with an exemplary embodiment of the invention, base 104 can include a substantially flat shaped bottom. A flat shaped bottom can be used to place base 104 on a flat surface.

In accordance with an exemplary embodiment, bottom component 351 can include can include a channel (not shown) extending through the body of bottom component 351. That is, bottom component 351 can combine with top component 350 such that channel 301 extends through at least a portion of bottom component 351. For example, bottom component 351 can include a top surface including an opening, a bottom surface, and a sidewall surface. Similar to top component 350, bottom component 351 can include an opening that can be located in either bottom surface and/or sidewall surface of bottom component 351. A material can extend from the top surface to the bottom surface of bottom component 351. As the material extends from the top surface to bottom surface, a channel (not shown) can be created connecting two opening that can be located in either bottom surface and/or sidewall surface to the top surface such that bottom component 351 can include an internal surface and an external surface.

For ease each of the above openings and channel in bottom component 351 are, at times, not illustratively depicted. This is merely for ease and is in no way meant to be a limitation. As bottom component 351 and top component 350 can be combined to form base 104 it will be understood that any description for base 104 can further describe each of the bottom component 351 and top component 350. For ease, at times, only the term base 104 is used. This is in no way meant to be a limitation.

In accordance with an exemplary embodiment of the invention, opening 306 and opening 308 can be any reasonable shape, such as, but not limit to round, square, polygonal, triangular, star shaped, or any other reasonable shape for receiving a string of lights. For ease, openings 306 and 308 are depicted as round, this is in no way meant to be a limitation. Further, channel 301 connecting opening 306 and opening 308 can follow any desired path. For example, channel 301 can change shape when connecting opening 306 and opening 308. By way of example, opening 306 and 308 may be square however the length of channel 301 connecting the square openings can be substantially round.

In accordance with an exemplary embodiment of the invention, base 104 can be a substantially rigid body that can include a substantially flat top surface, substantially flat and/or substantially pointed bottom surface, and a channel (not shown) for receiving a string of lights. That is, the substantially flat top surface can be coupled to shaft 106 and substantially pointed bottom surface extend from shaft 106 forming a substantial point (e.g., to be inserted into a surface). In accordance with an exemplary embodiment of the invention, base 104 can taper down from at least one of flat top surface and/or an opening to substantially pointed bottom surface. Further, in the region where tapering occurs the external surface of base 104 can include a geometric protrusion, such as, but not limited to, a thread, a barb, or any other reasonable geometric protrusion for aiding in placing at least some of the tapered region into a surface.

In accordance with an exemplary embodiment of the invention, base 104 can be any reasonable shape, such as, but not limited to, columnar, pyramidal, conical, or any other reasonable shape for positioning on a substantially flat surface and/or partially placing into a surface such that the portion of the light illuminating system illuminating the transparent object extends vertically from the surface.

In accordance with an exemplary embodiment of the invention, base 104 can be designed to receive a string of lights. For example, base 104 can include a channel (not shown) extending through the body of base 104.

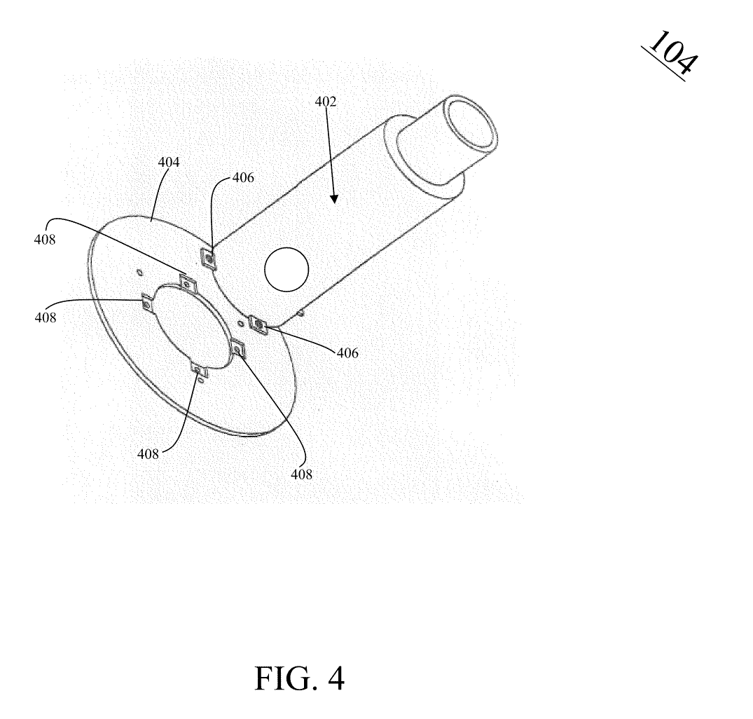

Referring to FIG. 4, in accordance with an exemplary embodiment of the invention, base 104 can include a single substantially rigid body and/or can include at least two substantially rigid bodies coupled together. Base 104 can include a first base body 402 and a second base body 404 that can be coupled together creating base 104. In accordance with an exemplary embodiment of the invention, first base body 402 can include at least one base coupling region 406 and second base body 404 can include at least one base coupling region 408, base coupling region 406 and base coupling region 408 being in contact with each other when first base body 402 is coupled to second base body 404.

In accordance with an exemplary embodiment first base body 402 can be coupled to second base body 404 by fasteners (not shown), such as, but not limited to, screws, batten, bi-metallic fastener, bolt, screw, cap screw, stud, brass fastener, buckle, button, clamp (or cramp), clasp, Bocklebee clasp, Cleko, clip, circlip, clutch (pin fastener), flange, frog, grommet, nail, peg, pin, clevis pin, cotter pin, linchpin, R-clip, retaining ring, external circlip, internal circlip, e-ring, rivet, screw, screw anchor, self-drilling fasteners, self-tapping fasteners, snap, staple, stitches, strap, tack, tie, toggle, or any other reasonable fastener. It will be understood that similar techniques can be used to join top base component 350 and bottom base component 351. In accordance with an exemplary embodiments, first base body 402 can be connected to second base body 404 by any reasonable adhesive such as, but not limited to, urea-formaldehyde, resorcinol, phenol formaldehyde resin, animal glues, polyvinyl acetate, polyurethane glue, epoxy, cyanoacrylate, contact cement, hot melt, hot bitumen, cold adhesives, or any reasonable adhesive. It will be understood that similar techniques can be used to join top base component 350 and bottom base component 351.

Referring back to FIG. 3A, base 104 can include a first base body region 322 and a second base body region 324. By comparing first base body region 322 and second base body region 324 shown in FIG. 3A (e.g., for base 104 constructed of a single rigid body) to first base body 402 and second base body 404 shown in FIG. 4 (e.g., for base 104 constructed of at least two rigid bodies), first base body region 322 and first base body 402 can be substantially similar and second base body region 324 and second base body 404 can be substantially similar. It will be understood that descriptions for either of first base body 402 and first base body region 322 and/or second base body 404 and second base body region 324 can be interchanged.

In accordance with an exemplary embodiment of the invention, first base body 402 and/or first base body region 324 can have any reasonable shape, such as, but not limited to square, oval, ovoid, rectangular, round columnar, square columnar, polygonal columnar, star columnar, triangular columnar, or any other reasonable columnar shape. For ease, each of the figures illustratively depicts first base body 402 and/or first base body region 324 as having a round columnar shape, this is in no way meant to be a limitation.

In accordance with an exemplary embodiment of the invention, second base body 404 and/or second base body region 324 can be any reasonable shape, such as, but not limited to columnar, square, round, ovoid, rectangular, flat, disc shaped, or any other reasonable shape.

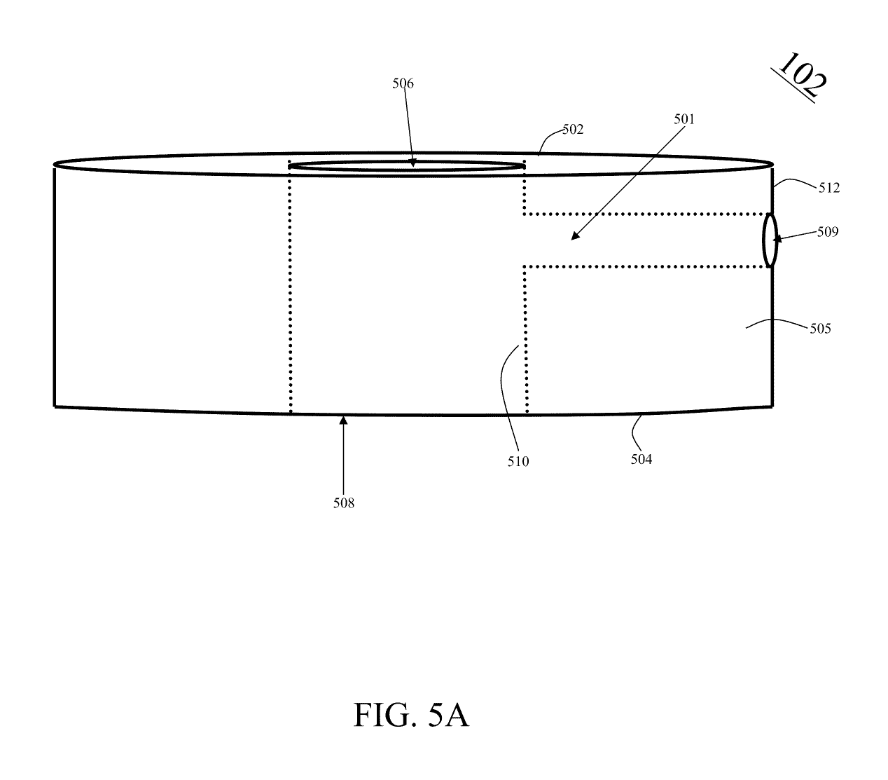

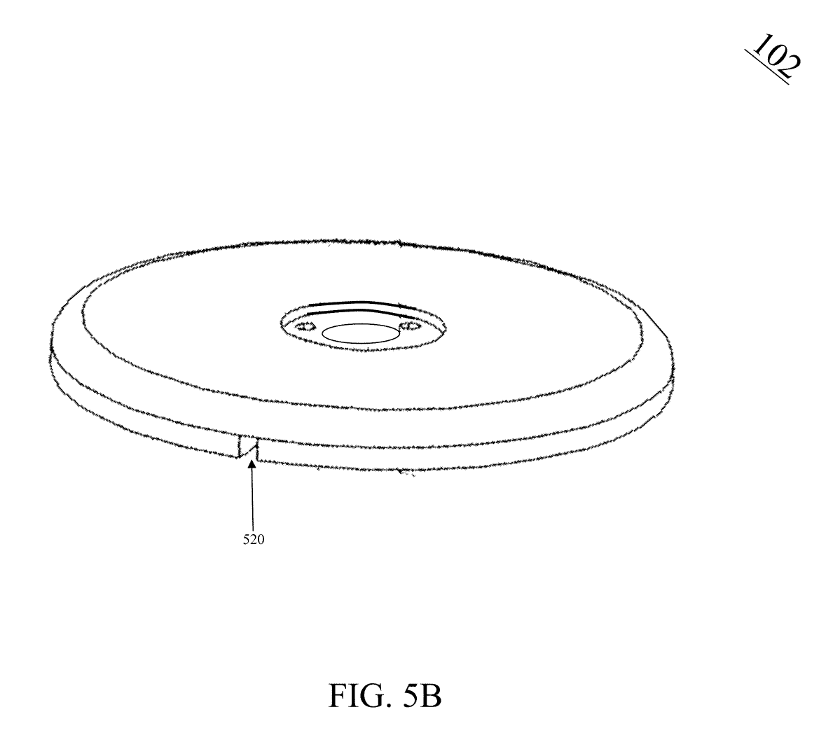

Referring to FIG. 5A, in accordance with an exemplary embodiment of the invention, positioner 102 can be a substantially rigid body that can include a substantially flat top surface 502, substantially flat bottom surface 504, and a channel 501 for receiving base 104 and/or for receiving a string of lights. For example, positioner 102 can be designed to surround (e.g., substantially encapsulate) at least a portion of base 104. In accordance with an exemplary embodiment of the invention, positioner 102 can be substantially heavier than base 104 and/or transparent shaft 106. Positioner 102 may, for example, be substantially heavy in order to maintain transparent shaft 106 in a vertical position (e.g., to avoid tipping in the wind).

Still referring to FIG. 5A, in accordance with an exemplary embodiment of the invention, positioner 102 can include a channel 501 extending through the body of positioner 102. Positioner 102 can include a top surface 502 including an opening 506, a bottom surface 504 including an opening 508, and a sidewall surface 505 including an opening 509. A material can extend from top surface 502 to bottom surface 504. As the material extends from top surface 502 to bottom surface 504, channel 501 can be created connecting opening 508 and opening 506. Positioner 102 can include an internal surface 510 and an external surface 512. Further, channel 501 can connect opening 509 and internal surface 510.

Referring to FIG. 5B, in accordance with an exemplary embodiment of the invention, channel 501 can extend substantially along the bottom surface of positioner 102 such that an open channel 520 runs along at least a portion of positioner 102. For example, a wire for providing electricity to a string of lights can be located in open channel 520.

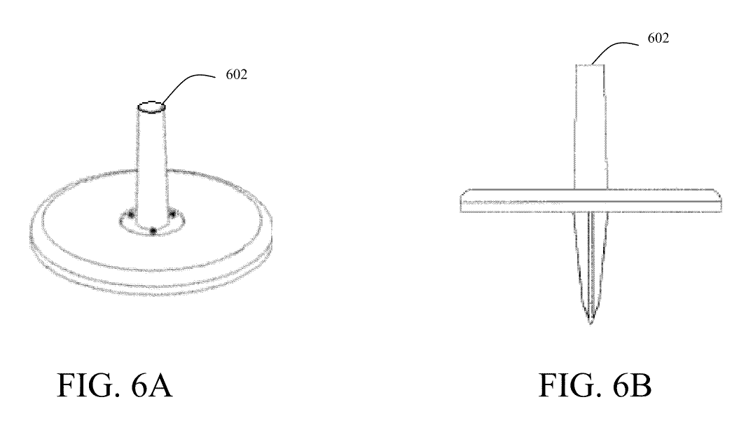

Referring to FIG. 6A-6B, in accordance with an exemplary embodiment of the invention, each of positioner 102 and base 104 can be combined as a single unit. In accordance with an exemplary embodiment, shaft 106 (not shown) can be coupled to positioner 102 and base 104 (e.g., combined as one unit) at a coupling region 602. In accordance with an exemplary embodiment, positioner 102 and base 104 (e.g., combined as one unit) can include a channel (not shown) for receiving a string of lights. In accordance with an exemplary embodiment, positioner 102 and base 104 (e.g., combined as one unit) can not include a channel (not shown) for receiving a string of lights as the string of lights can be received by shaft 106 (not shown). It will be understood positioner 102 and base 104 (e.g., combined as one unit) can include any of the descriptions for positioner 102 and base 104 described herein. In accordance with an exemplary embodiment, positioner 102 and base 104 (e.g., combined as one unit) can have any reasonable shape capable of maintaining shaft 106 in the vertical position.

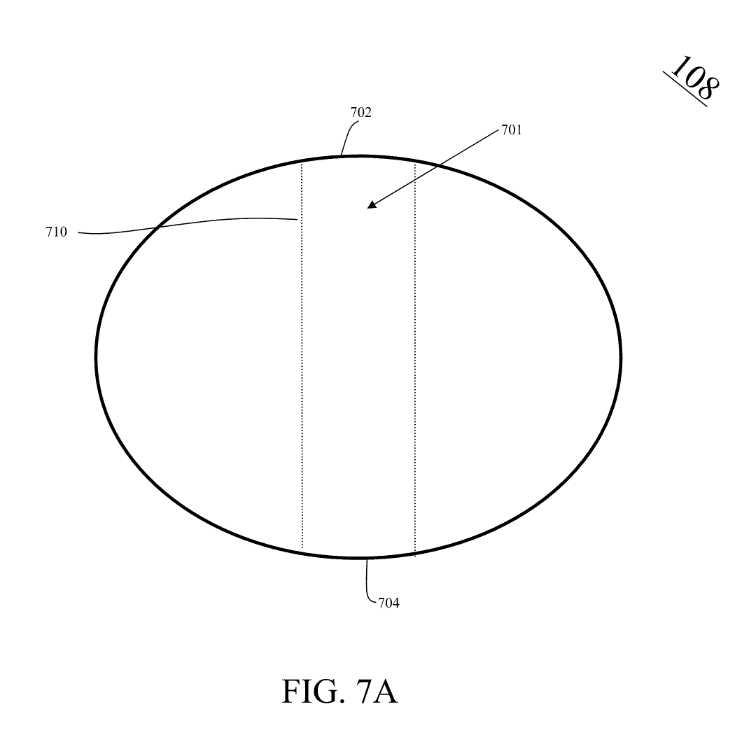

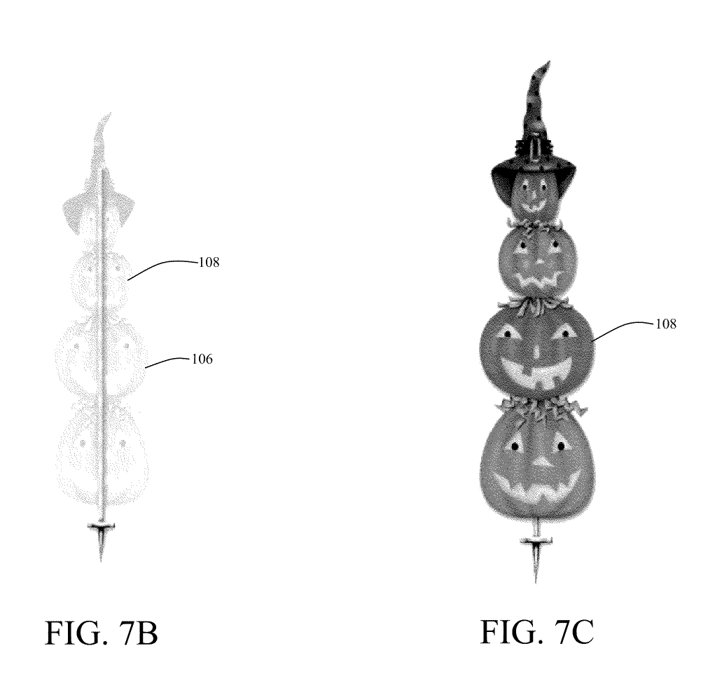

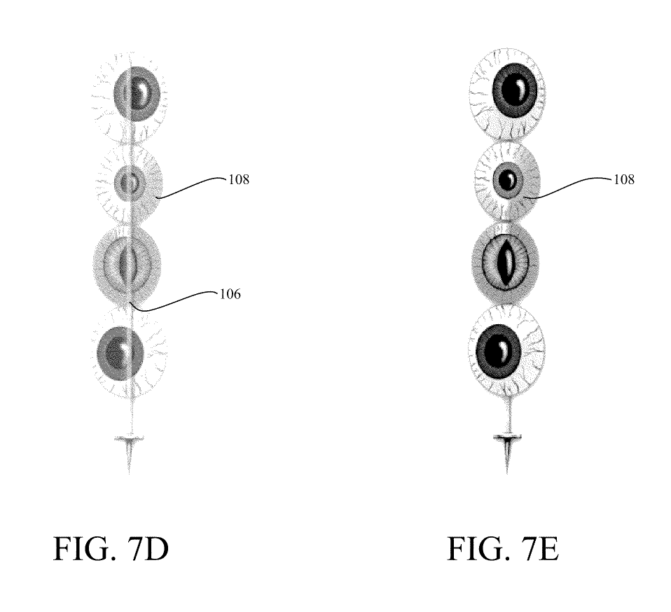

Referring to FIG. 7A, in accordance with an exemplary embodiment of the invention, transparent object 108 can be any reasonable shape including a first opening 702 and a second opening 704, such that transparent shaft 106 can be received through first opening 702 and second opening 704. For example, transparent object 108 can be placed on transparent shaft 106 by passing transparent shaft 106 through a channel 701 connecting first opening 702 and second opening 704.

In accordance with an exemplary embodiment of the invention, transparent object 108 can include an internal surface 710 that can be substantially smooth and/or can be substantially rough. Internal surface 710 can be substantially smooth, for example, to ease the passage of transparent shaft 106. Internal surface 710 can be substantially rough, for example, for frictional position of transparent object 108 on transparent shaft 106.

In accordance with an exemplary embodiment of the invention, transparent object 108 can be substantially hollow. For example, the internal surface of transparent object 108 can have negligible contact with transparent shaft 106 because, for example, the width of transparent shaft 106 can be substantially smaller than the amount of space within the transparent object.

Referring to FIG. 7B-7E, in accordance with an exemplary embodiment of the invention, transparent object 108 can be any reasonable shape including a first opening 702 (not shown), such that transparent shaft 106 can be received through first opening 702 (not shown) and into the transparent object. As shown, transparent shaft 106 can extend into the body of transparent object 108 such that transparent object 108 substantially encapsulates transparent shaft 106. Referring to FIGS. 7B-7C, by way of example, transparent shaft 106 can be placed into transparent object 108, shaped as a plurality of pumpkins stacked vertically with a hat at the highest point, such that the highest point of transparent shaft 106 is located within the hat. Referring to FIGS. 7D-7E, by way of example, transparent shaft 106 can be placed into transparent object 108, shaped as a series of vertically stacked eyeballs, such that highest point of transparent shaft 106 is located within the highest eyeball.

In accordance with an exemplary embodiment of the invention, any plurality of transparent objects can be placed on transparent shaft 106. That is, a single transparent object having a single opening can be placed on transparent shaft 106, a plurality of transparent objects having at least two opening can be placed on transparent shaft 106, and/or a combination of one or more transparent objects having at least two openings and at least one transparent object having a single opening can be placed on transparent shaft.

In accordance with an exemplary embodiment of the invention, transparent object 108 can be made of a transparent materials, such as, but not limited to, paper, a fabric (e.g., cotton, nylon, etc.), a polymer (e.g., Polyvinyl Chloride, etc.), or any other reasonable transparent material. In accordance with an exemplary embodiment of the invention, transparent object 108 can include any reasonable ornamental shape.

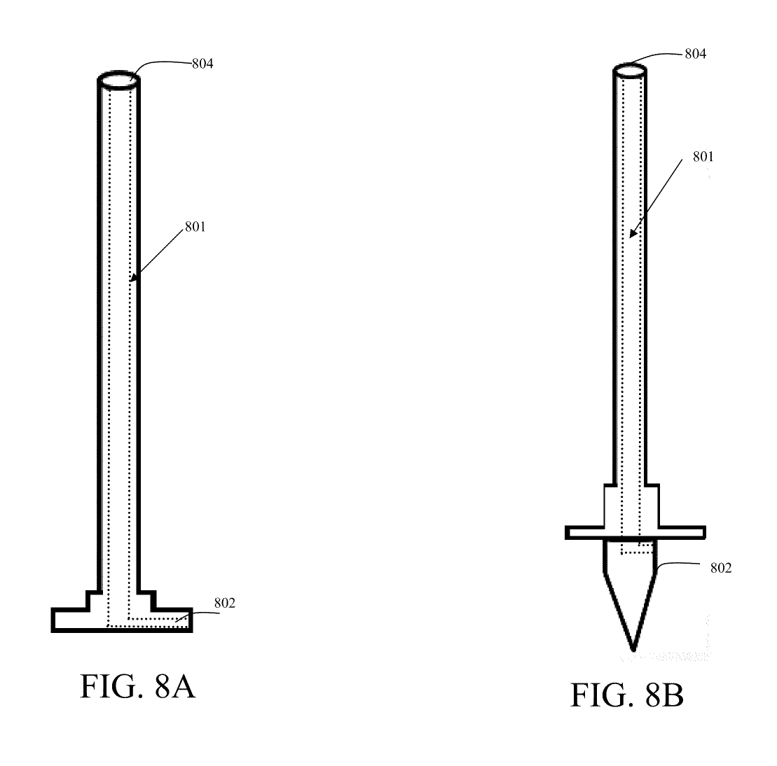

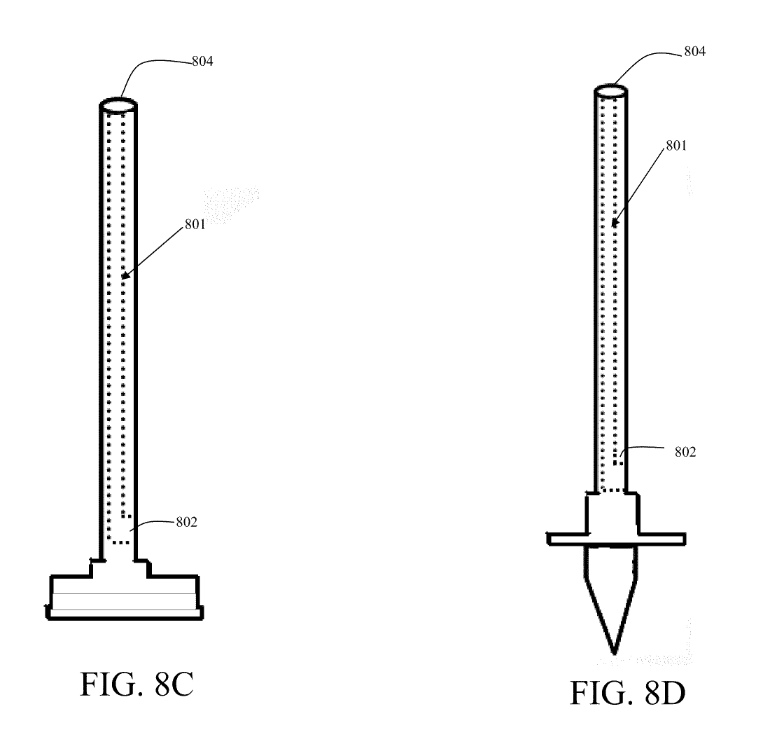

Referring to FIGS. 8A-8B, in accordance with an exemplary embodiment of the invention, channel 501 in positioner 102, channel 301 in base 104, and channel 201 in transparent shaft 106 can connect forming a single channel 801 having a first opening 802 in positioner 102 and a second opening 804 in transparent shaft 106. As shown, in accordance with an exemplary embodiment of the invention, first opening 802 can be at an angle to second opening 804. For example, first opening 802 can be perpendicular to second opening 804.

Referring to FIGS. 8C-8D, in accordance with an exemplary embodiment of the invention, transparent shaft 106 can include a single channel 801 having a first opening 802 in the sidewall of transparent shaft 106 and can include a second opening 804. In accordance with an exemplary embodiment of the invention, channel 801 can include only a single opening (e.g., first opening 802).

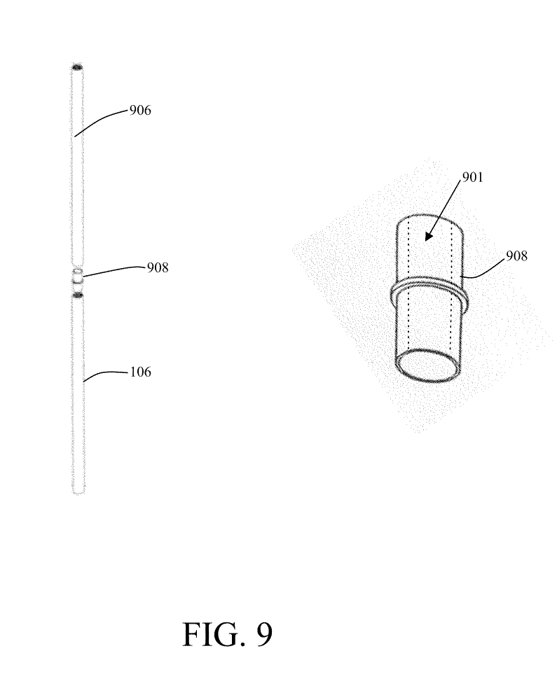

Referring to FIG. 9, in accordance with an exemplary embodiment of the invention, an at least one more transparent shaft can be connected to first transparent shaft 106 extending the vertical height of the illuminating system. As shown, second transparent shaft 906 can be connected to first transparent shaft 106. For ease, only one additional transparent shaft is added, however, any plurality of transparent shafts can be added without deviating from the scope of the invention. For example, a second transparent shaft can be connected to the first transparent shaft and a third transparent shaft can be connected to the second transparent shaft. In accordance with an exemplary embodiment of the invention, a connector 908 can be used to connect second transparent shaft 906 and first transparent shaft 106.

In accordance with an exemplary embodiment of the invention, the connector 908 can enable the combination of two or more transparent shafts 106 in a relatively small package and assembled by the purchaser into a relatively long assembly.

In accordance with an exemplary embodiment of the invention, a connector 908 can be substantially columnar in shape and have an opening passing from the top of the connector to the bottom of the connector. Connector 908 can be a substantially rigid transparent/translucent tube.

In accordance with an exemplary embodiment of the invention, connector 908 can be designed to receive a string of lights through the length of its body. For example, connector 908 can include a channel 901 extending through the length of connector 908. Channel 901 can be concentrically located within the length of connector 908. In accordance with an exemplary embodiment, connector 908 can be substantially transparent/translucent.

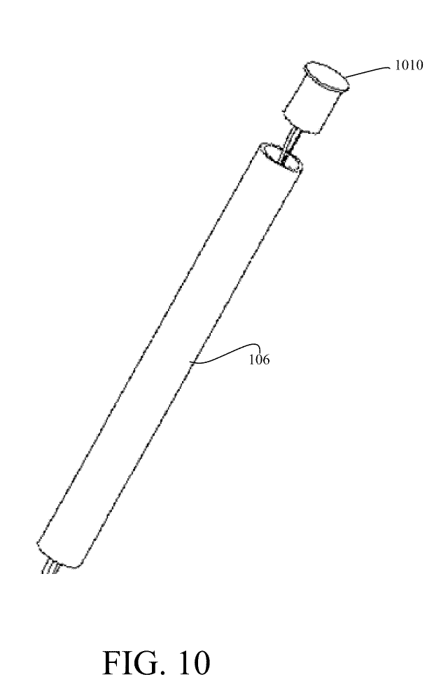

Referring to FIG. 10, in accordance with an exemplary embodiment of the invention, a cap 1010 can be located at the top of either transparent shaft 106 and/or at the top of an additional transparent shaft. Cap 1010 can include a string of lights catching mechanism that can, for example, assist in keeping the string of lights placed in the transparent shaft in a vertical position. For example, cap 1010 can include a friction fit that allows a light from the string of lights to be held in place within cap 1010. Cap 1010 can also be designed to prevent moisture (e.g., rain, snow, sleet, ice, etc) from entering the transparent shaft. Cap 1010 can be designed to fit within an opening at the top of the transparent shaft and/or have an opening in which the transparent shaft is placed into.

In accordance with an exemplary embodiment of the invention, at least one of positioner 102, base 104, base top component 350, base bottom component 351, transparent shaft 106, connector 908, and cap 1010 can include a coupling region. In accordance with an exemplary embodiment of the invention, the coupling region can be located such that at least one of transparent shaft 106 can be coupled to base 104, base 104 can be coupled to positioner 102, connector 908 can be coupled to transparent shaft 106, and cap can be coupled to transparent shaft 106. Further, the coupling region can be located such that at least one of top base top component 350 and base bottom component 351 can be coupled to each other.

In accordance with an exemplary embodiment of the invention, the coupling region of one component (e.g., positioner 102, base 104, combined positioner 102 and base 104, transparent shaft 106, base top component 350, base bottom component 351, connector 908, cap 1010, etc.) can be coupled to the coupling region of another component (e.g., positioner 102, base 104, combined positioner 102 and base 104, base top component 350, base bottom component 351, transparent shaft 106, connector 908, cap 1010, etc.) by inserting the coupling region of one component into the coupling region of another component. In accordance with an exemplary embodiment of the invention, the coupling region of one component can remain coupled to the coupling region of another component by any reasonable interaction, such as, but not limited to, a mechanical interaction (e.g., thread interaction, frictional interaction, etc.), a chemical interaction (e.g., bonding, melting, etc.), an adhesive interaction (e.g., adhesively contacting the coupling regions), or any other reasonable interaction capable of coupling the coupling regions.

In accordance with an exemplary embodiment of the invention, the coupling region of positioner 102, base 104, base top component 350, and base bottom component 351 can be coupled by a fastener such as, but not limited to, screws, batten, bi-metallic fastener, bolt, screw, cap screw, stud, brass fastener, buckle, button, clamp (or cramp), clasp, Bocklebee clasp, Cleko, clip, circlip, clutch (pin fastener), flange, frog, grommet, nail, peg, pin, clevis pin, cotter pin, linchpin, R-clip, retaining ring, external circlip, internal circlip, e-ring, rivet, screw, screw anchor, self-drilling fasteners, self-tapping fasteners, snap, staple, stitches, strap, tack, tie, toggle, or any other reasonable fastener.

In accordance with an exemplary embodiment of the invention, each of positioner 102, base 104, base top component 350, base bottom component 351, and transparent shaft 106 can be combined or further divided. For example, base 104 and positioner 102 can be combined into one unit. As a further example, positioner 102, base 104, and transparent shaft 106 can be combined into one unit. As yet a further example, discussed above, base 104 can be produced from more than one element combined to create base 104.

Now that exemplary embodiments of the present invention have been shown and described in detail, various modifications and improvements thereon will become readily apparent to those skilled in the art. Accordingly, the spirit and scope of the present invention is to be construed broadly and limited only by the appended claims, and not by the foregoing specification.

What is claimed is:

1. A light illuminating system, comprising:
at least one of a positioner and a base;
a first transparent shaft being coupled to at least one of the positioner and the base such that the transparent shaft extends vertically; and
the first transparent shaft including a hollow channel extending vertically through the first transparent shaft, the hollow channel being capable of receiving a string of lights for illuminating the first transparent shaft.

2. The light illuminating system of claim 1, further comprising at least one transparent object being located on the transparent shaft such that when the first transparent shaft is illuminated the at least one transparent object is illuminated.

3. The light illuminating system of claim 2, wherein the transparent object substantially encapsulates at least one of the length of the first transparent shaft and a portion of the length of the first transparent shaft.

4. The light illuminating system of claim 2, wherein transparent object is a three-dimensional shape.

5. The light illuminating system of claim 1, further comprising:
a second transparent shaft coupled to a first connector, the first connector being coupled to the first transparent shaft;
the second transparent shaft and the first connector each including a hollow channel capable of receiving a string of lights.

6. The light illuminating system of claim 1, wherein the positioner and the base are substantially one unit.

7. The light illuminating system of claim 1, wherein the transparent shaft, the positioner, and the base are substantially one unit.

8. The light illuminating system of claim 1, wherein the transparent shaft is constructed of Polyvinyl Chloride.

9. The light illuminating system of claim 2, wherein the transparent object is constructed of at least one of a polymer and a fabric.

10. The light illuminating system of claim 1, wherein at least two of the transparent shaft, base, and positioner are connect by being at least partially placed into one another.

11. The light illuminating system of claim 1, further comprising a cap, the cap being located on top of the vertical axis of the transparent shaft.

12. The light illuminating system of claim 11, wherein the cap is further comprising a connector for coupling the cap to a string of lights such that the string of lights remains vertically disposed within the channel of transparent shaft.

13. The light illuminating system of claim 1, wherein the first transparent shaft is further comprising at least one opening connected to the hollow channel such that a string of lights can be received in the channel.

14. The light illuminating system of claim 13, wherein the opening is located at least one of on the bottom of the vertical axis of the transparent shaft and on the sidewall of the transparent shaft.

15. The light illuminating system of claim 14, wherein the opening is located on the sidewall of the transparent shaft such that the hollow channel is comprising a first external opening on the sidewall of the transparent shaft.

16. The light illuminating system of claim 14, wherein at least one of the positioner and the base are comprising a hollow channel having a first opening and second opening, each of the hollow channels of the first transparent shaft and at least one of the positioner and the base being connected forming a single hollow channel inside the light illuminating system,
the single hollow channel having a first external opening located on the external surface of at least one of the positioner and the base.

17. The light illuminating system of claim 1, wherein the first transparent shaft is further comprising:
a first opening located on the top of the vertical axis of the transparent shaft; and
a second opening located at least one of on the bottom of vertical axis of the transparent shaft and on the sidewall of the transparent shaft; and
wherein the first and second opening connect to the hollow channel of the first transparent shaft.

18. The light illuminating system of claim 17, wherein the second opening is located on the sidewall of the transparent shaft such that the hollow channel is having a first external opening on the sidewall of the transparent shaft and a second external opening located on the top of the vertical axis of the transparent shaft.

19. The light illuminating system of claim 17, wherein at least one of the positioner and the base are comprising a hollow channel having a first opening and second opening, each of the hollow channels of the first transparent shaft and at least one of the positioner and the base being connected forming a single hollow channel inside the light illuminating system; and
the single hollow channel having a first external opening located on the external surface of at least one of the positioner and the base and a second external opening located substantially near the top region of the first transparent shaft.

20. The light illuminating system of claim 1, wherein the base is further comprising a shape of at least one of substantially columnar having a substantially flat bottom surface and conical shaped having a substantially pointed bottom surface.

21. The light illuminating system of claim 2, wherein the at least one transparent object is further comprising at least one of a first opening and a second opening, such that the transparent object is located on the transparent shaft by passing the transparent shaft through at least one of the first opening and second opening of the transparent object.

22. The light illuminating system of claim 2, further comprising a second transparent object having a first opening and a second opening; and
the second transparent object being located on the transparent shaft below the first transparent, the second transparent object being located on the transparent shaft by passing the transparent shaft through the first and second opening.

23. The light illuminating system of claim 1, wherein the transparent shaft is further comprising an internal surface and an external surface; and
wherein the internal surface of the transparent shaft is substantially rough for frictionally positioning the string of lights in the transparent shaft.

24. The light illuminating system of claim 2, wherein the transparent shaft is further comprising an external surface and the transparent object is further comprising an internal surface; and
wherein at least one of the external surface of the transparent shaft and the internal surface of the transparent object are substantially rough for frictionally positioning the transparent object on the transparent shaft.

25. The light illuminating system of claim 1, wherein the transparent shaft is further comprising a plurality of transparent shaft elements capable of telescoping out.

26. A method of illuminating an object, comprising:
placing at least one of a base and positioner at least one of on a surface and partially into a surface such that a transparent shaft extends vertically from the surface, the transparent shaft having a string of lights disposed within it; and
illuminating the vertically extending transparent shaft.

27. The method of illuminating an object of claim 26, further comprising placing an object over a vertically extending transparent shaft such that the transparent shaft is at least partially encapsulated.

28. A light illuminating system, comprising:
a string of lights;
at least one of a positioner and a base;
a first transparent shaft being coupled to at least one of the positioner and the base such that the transparent shaft extends vertically; and
the first transparent shaft including a hollow channel extending vertically through the first transparent shaft, the hollow channel substantially housing the string of lights for illuminating the first transparent shaft.

29. The light illuminating system of claim 28, further comprising at least one transparent object being located on the transparent shaft such that when the first transparent shaft is illuminated the at least one transparent object is illuminated.

30. The light illuminating system of claim 29, wherein the transparent object substantially encapsulates at least one of the length of the first transparent shaft and a portion of the length of the first transparent shaft.

31. The light illuminating system of claim 28, wherein transparent object is a three-dimensional shape.

32. The light illuminating system of claim 28, wherein the string of lights is at least one of a string of light-emitting diodes (LEDs), incandescent lights, fiber optic lights, and bubble lights.

33. The light illuminating system of claim 29, wherein the transparent shaft is further comprising a plurality of transparent shaft elements capable of telescoping out.
